(19) United States
(12) Patent Application Publication
(10) Pub. No.: US 2003/0198177 A1
(43) Pub. Date: Oct. 23, 2003

(54) Holographic recording medium cartridge

(76) Inventors: Hideyoshi Horimai, Numazu-shi (JP); Kozo Matsumoto, Yokohama-shi (JP)

Correspondence Address: Mark Montague, Esq., Cowan, Liebowitz & Latman, P.C., 1133 Avenue of the Americas, New York, NY, 10036, US

(21) Appl. No.: 10/410,814

(22) Filed: Apr. 10, 2003

(30) Foreign Application Priority Data
Apr. 22, 2002 (JP) P2002-118478

(51) Int. Cl. G11B 23/03

(52) U.S. Cl. 369/291

(57) ABSTRACT

A cartridge for storing a holographic recording medium designed to allow a user to check whether a holographic recording medium is contained within the cartridge. The cartridge includes a disc tray on which a recording medium may be mounted and a housing that is capable of accommodating the disc tray and wherein a side surface of the housing may be opened. The housing is constructed to prevent the passage into its interior of light to which the recording medium is sensitive (dead band color). The housing, however, includes at least a portion that allows the passage into its interior of light to which the recording medium is not sensitive (e.g., orange through red colors), to allow the cartridge to be visually checked to determine whether a recording medium is contained within it. To further prevent the passage of any damaging light into the cartridge's interior, an elastic (e.g., sponge-like) light shielding material called MOLTOPREN is wound over a circumference of the plate part at a portion of a plate part of the disc tray which is is bonded to a holding part.

### BACKGROUND OF THE INVENTION

1. Field of the Invention

This invention relates to a cartridge for accommodating a holographic recording medium.

2. Description of the Related Art

A holographic recording system in which data is recorded on a recording medium by a hologram is in the spotlight (e.g., see JP-A-2001-256654 and JP-A-2002-83431). In general, since a holographic recording medium uses a photosensitive material as a recording material, there is a necessity to block it from light in order to avoid unnecessary light-exposure, and normally, it is accommodated in a light shielding container.

However, since it is not only troublesome to take out the recording medium from the container, in each case of recording or reproducing but also it has to be taken out in a dark room, it may be inconvenient for a user to handle it. Accordingly, desired is a cartridge in which a recording medium can be mechanically taken out and in, and can be completely blocked from light at the time of non-use.

In addition, it is convenient if it can be checked, by looking at from an outside, that the recording medium is contained inside the cartridge.

### OBJECT AND SUMMARY OF THE INVENTION

The object of this invention is to provide a cartridge for a holographic recording medium that satisfies the above-mentioned desires.

A holographic recording medium cartridge according to the invention comprises a housing for shielding light of a color to which a holographic recording medium is sensitive and is characterized in that visible light of color to which the holographic recording medium is insensitive passes through at least a part of the housing.

Also, a holographic recording medium cartridge according to the invention has a disc tray on which the holographic recording medium is mounted, and a housing having an opening for taking out and in the disc tray and for shielding light of a color responsive to the holographic recording medium and is characterized in that visible light which is a non-responsive color of the holographic recording medium passes through at least a part of the housing.

Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is an exploded perspective view of a first embodiment of the invention;

FIG. 2 is a plan view of a disc tray 14 in a state when a recording medium 12 is mounted thereon;

FIG. 3 is a plan view of a state when the disc tray 14 is accommodated in a housing 16;

FIG. 4 is a cross-sectional view of a portion of a light shielding material 22, seen from an A-A line of FIG. 2;

FIG. 5 is a perspective view of a state when the disc tray 14 is completely accommodated in the housing 16;

FIG. 6 is a perspective view of a state when a shutter is open in a second embodiment;

FIG. 7 is a perspective view of a state when the shutter is closed in the second embodiment;

FIG. 8 is a cross-sectional view of a B-B line of FIG. 7;

FIG. 9 is a cross-sectional view of a C-C line of FIG. 7; and

FIG. 10 is an exploded perspective view of the second embodiment (main parts).

### DETAILED DESCRIPTION OF PREFERRED EMBODIMENTS

Hereinafter, embodiments of the invention will be described by reference to the drawings. In addition, a dimension of a vertical axis of the drawing is not proportional. In order to facilitate understanding, it is shown properly in an exaggerated form.

First Embodiment

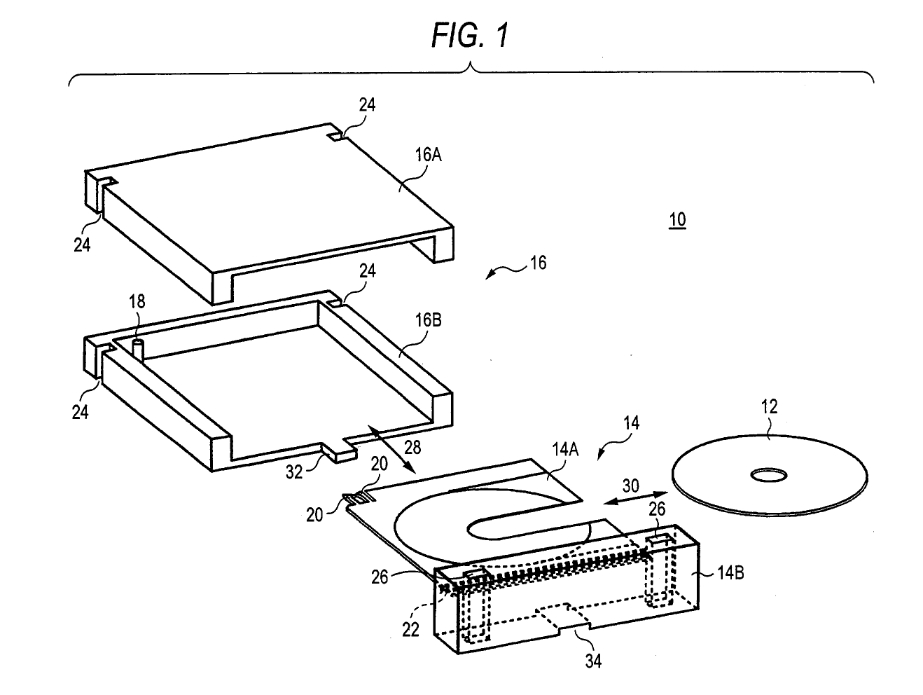

FIG. 1 shows an exploded perspective view of the first embodiment of the invention. A cartridge 10 of the embodiment comprises a disc tray 14 on which a recording medium 12 is mounted, and a housing 16 which is capable of accommodating the disc tray 14 and only one side surface of which is open. The housing 16 comprises an upper half body 16A and a lower half body 16B.

In this embodiment, a color of the housing 16 is set to a color that does not pass light sensitive to the recording medium 12 (dead band color). Since it is convenient if it can be checked from outside the housing 16 whether the recording medium 12 is contained in the housing 16, the entire upper half body 16A, or at least a portion necessary for visually observing the recording medium 12 inside, is set to a color which is the dead band color of the recording medium 12 and that also passes visible light. As a holographic recording medium, photo-polymer has been proposed. This responds to a green color but does not respond to orange through red colors. Therefore, the entire upper half body 16A or a part of the upper half body 16A is set to the orange through red colors.

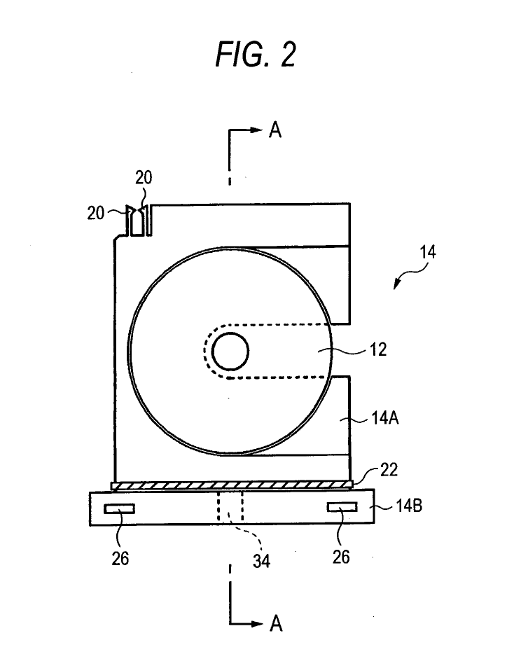

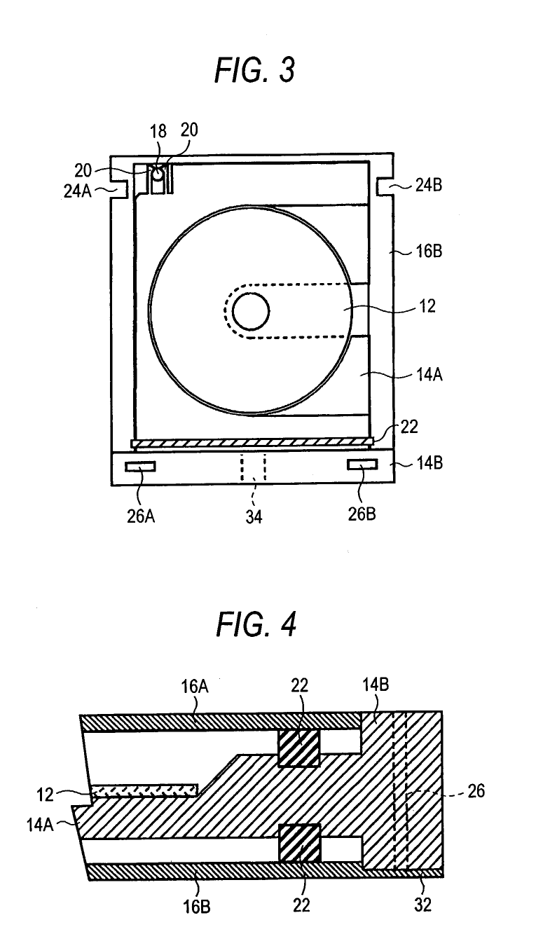

FIG. 2 shows a plan view of the disc tray 14 in a state when the recording medium 12 is mounted thereon, and FIG. 3 shows a plan view of a state when the disc tray 14 is accommodated in the housing 16. In order to easily understand an inner structure, in FIG. 3, the upper half body 16A is shown removed.

At an inmost part of the housing 16, disposed is a lock pin 18 for holding the disc tray 14 which is accommodated in the housing 16. To correspond to this lock pin 18, at a tip portion of the disc tray 14 on the occasion of being inserted into the housing 16, disposed are two elastic claws 20 which can be latched to the lock pin 18 and face each other. The lock pin 18 and the elastic claws 20 make up a lock mechanism for holding the disc tray 14 to a state when it is accommodated in the housing 16.

In disc tray 14, at one end of a plate part 14A for holding the recording medium 12 itself, fixed is a holding part 14B which is used when the disc tray 14 is pulled out from the housing 16. The holding part 14B is of such a size that it closes an opening of the housing 16, when the disc tray 14 is accommodated in the housing 16. Since there is, to a certain extent, a gap between the holding part 14B and the housing 16 and there is a possibility that light gets in through it, in this embodiment, an elastic (sponge-like) light shielding material 22 called as MOLTOPREN is wound, as shown in FIG. 4, at a portion of a plate part 14A which is bonded to the holding part 14B and over a circumference of the plate part 14A. FIG. 4 shows a cross-sectional view of a portion of the light shielding material 22, seen from an A-A line of FIG. 2.

At both side surfaces of the housing 16, formed are concaves 24A and 24B for holding the cartridge 10 in a drive apparatus of the recording medium 12. Also, in the holding part 14B of the disc tray 14, disposed are openings 26A and 26B that are used for taking out and in the disc tray 14 to the housing 16. Under a state that hooks (not shown) are engaged with the concaves 24A and 24B and the cartridge 10 is fixed, by inserting other hooks into the openings 26A and 26B, it is possible to take out and in the disc tray 14 to the housing 16.

An arrow 28 of FIG. 1 shows the moving direction of the disc tray 14, and an arrow 30 shows the direction of taking out and in the recording medium 12 from the disc tray 14 which is taken out from the housing 16. In this manner, by making the moving direction 28 of the disc tray 14 perpendicular to the moving direction of the recording medium 12, it is possible to effectively take out and in the recording medium 12 from the cartridge 10 in a narrow space.

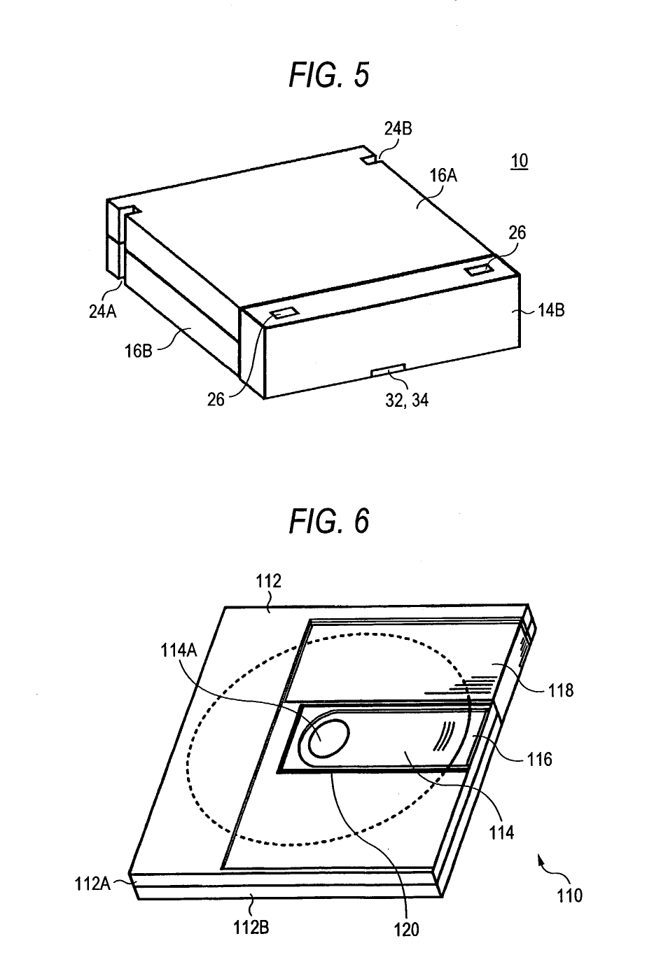

In this embodiment, further, a tongue piece 32 is projected from at least a part of the lower half body 16B toward the holding part 14B, and a concave 34 is formed at a corresponding portion in the holding part 14B. By this, as shown in FIG. 5, in a state when the disc tray 14 is completely accommodated in the housing 16, the tongue piece 32 is contained in the concave 34, and a bottom surface of the holding part 14B is flattened. When a user tries to take out the disc tray 14 from the housing 16 by his/her own hand, he/she tries to take out the disc tray 14 from the housing 16, by holding the holding part 14B tightly at its upper surface and bottom surface. At that time, since the tongue piece 32 and the holding part 14B are held together, it is impossible to take out the disc tray 14 from the housing 16. Therefore, it is possible to prevent the recording medium 12 from being exposed improperly.

Second Embodiment

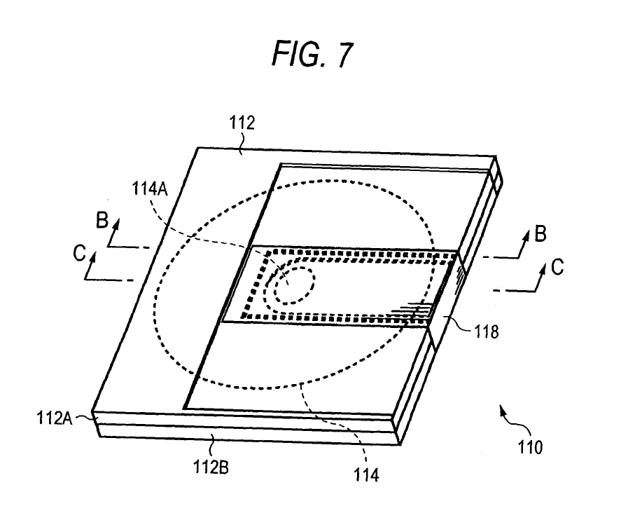

This invention is also applicable to a cartridge having a shutter function. FIGS. 6 and 7 show perspective views of an embodiment of the cartridge having the shutter. FIG. 6 shows a state when the shutter is open, and FIG. 7 shows a state when the shutter is closed. The shutter mechanism itself is made by the same structure as that adopted in a 3.5 inch magneto-optical disc, etc.

A housing 112 of this embodiment 110 comprises an upper half body 112A and a lower half body 112B, and in its inside, a holographic recording medium 114 is accommodated. In the same manner as the first embodiment shown in FIGS. 1 through 5, the housing 112 is of a color which does not pass light sensitive to the recording medium 114 (dead band color). To conveniently check from an outside if the recording medium 114 is accommodated in the housing 112, the entire upper half body 112A, or at least a portion necessary for visually observing the recording medium 114 inside, is set to a color that is the dead band color of the recording medium 114 and a color that passes visible light, the orange through red colors.

The housing 112 has openings 116 at both upper and bottom surfaces. The openings 116 are formed to be sufficiently large so that it is possible to access a recording area of the recording medium 114 through it, and a spindle axis of a drive apparatus can be inserted into a center hole 114A of the recording medium 114. Only opening at one side surface of the housing 112 may be formed to be sufficiently large so that the spindle axis of the drive apparatus can be inserted into the center hole 114A of the recording medium 114.

A shutter 118 comprises a U shaped stainless plate, and by a spring (not shown), is biased in a direction for closing the opening 116. The shutter 118 is of a sufficient size to close the opening 116 completely. On an outer surface of the housing 112, so as to go around the openings 116 on the both surfaces, a light shielding material 120 made of MOLTOPREN is embedded. As shown in FIG. 7, the light shielding material 120 is designed to prevent light from leaking in the inside of the housing 112 by filling a gap between the shutter 118 and the opening 116 when the shutter 118 is closed.

In addition, the embodiment 110 is of such a structure that the shutter 118 can be also opened in an opposite direction to the opening and closing direction shown in FIG. 6, and is applicable to a double-sided recording disc.

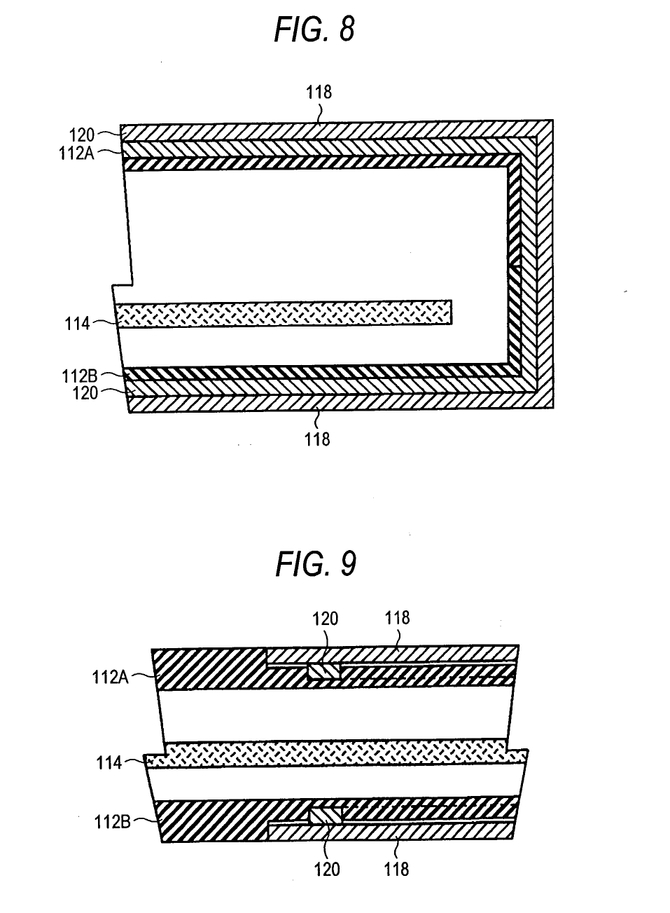

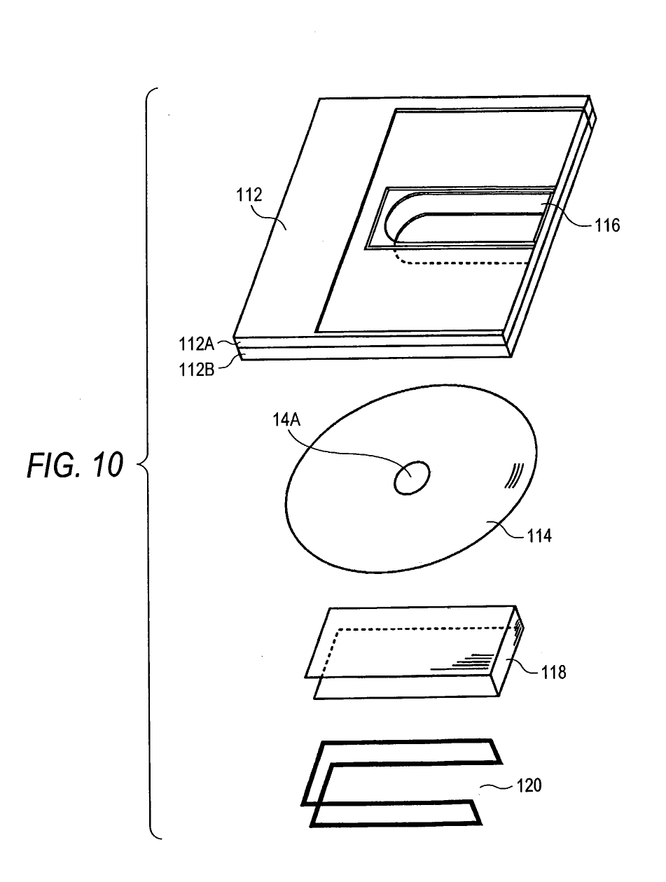

FIG. 8 shows a cross-sectional view of a B-B line of FIG. 7, and FIG. 9 shows a cross-sectional view of a C-C line of FIG. 7. Both views show only a portion of the light shielding material 120. FIG. 10 is an exploded perspective view of the second embodiment, and shows only main parts. As shown in FIG. 10, MOLTOPREN is made to be of loop shape, and as the light shielding material 120, embedded around the opening 116 as shown in FIG. 6.

As can be easily understood from the above-described explanation, according to the invention, it can be visually checked if the recording medium is contained inside, which is convenient. Also, since the cartridge is made of a material that shields light sensitive to the recording medium, it is possible to avoid unnecessary light-exposure of the recording medium which is contained inside, and thereby to avoid wasting recording capacity. Further, since the gap is closed by the light shielding material, light never comes into the inside of the cartridge from outside at the time of non-use, and it is possible to avoid unnecessary light-exposure of the recording medium due to incoming light.

It is intended that the appended claims be interpreted as including the embodiments described herein, the alternatives mentioned above, and all equivalents thereto.

What is claimed is:

1. A holographic recording medium cartridge comprising:
a housing for shielding a light of color to which a holographic recording medium is sensitive,
wherein at least a part of the housing passes visible light of color to which the holographic recording medium is insensitive.

2. The holographic recording medium cartridge as set forth in claim 1, further comprising:
a lid body for closing an opening disposed on the housing for accessing the holographic recording medium; and
a light shielding material for shielding a gap located around the opening and with the lid body.

3. The holographic recording medium cartridge as set forth in claim 1, further comprising:
a lid body for closing an opening disposed on the housing for accessing the holographic recording medium and at least a part of which has a projected part and on which body, a concave for accommodating the projected part is disposed.

4. A holographic recording medium cartridge, comprising:
a disc tray on which a holographic recording medium may be mounted; and
a housing having an opening for taking in and out the disc tray and for shielding light of a color to which the holographic recording medium is sensitive,
wherein at least a part of the housing passes visible light of color to which the holographic recording medium is not sensitive.

5. The holographic recording medium cartridge as set forth in claim 4, further comprising a lock mechanism for fixing the disc tray to inside of the housing.
